(19) United States
(12) Patent Application Publication
(10) Pub. No.: US 2016/0090175 A1
(43) Pub. Date: Mar. 31, 2016

(54) MECHANICAL ASSEMBLY HAVING ENHANCED BEHAVIOR WITH RESPECT TO FATIGUE-FRICTION DUE TO MICRO-MOVEMENTS

(71) Applicants: EUROPEAN AERONAUTIC DEFENCE AND SPACE COMPANY EADS FRANCE, Paris (FR); EUROCOPTER, Marignane Cedex (FR)

(72) Inventors: Ludovic ROPARS, Paris (FR); Sophie GOURDET, La Verriere (FR); Daniel LECURU, Velaux (FR)

(21) Appl. No.: 14/889,732

(22) PCT Filed: May 7, 2014
(86) PCT No.: PCT/EP2014/059387

§ 371 Date: Nov. 6, 2015

(30) Foreign Application Priority Data
May 7, 2013 (FR) 1354191

(51) Int. Cl. B64C 27/32; B22F 7/00; F16C 3/02; B22F 7/06; C22C 14/00; C22C 32/00

(52) U.S. Cl. CPC B64C 27/32; C22C 14/00; C22C 32/0047; F16C 3/02; B22F 7/06; B22F 7/008

(57) ABSTRACT

A mechanical assembly having improved behavior with respect to fatigue combined with wear due to micro-movements, wherein the assembly includes at least two parts that are attached to one another. At least one of the at least two parts is made of a material including a titanium or titanium-alloy matrix and including titanium-carbide or titanium-boride ceramic particles which are substantially homogeneously dispersed within the matrix, wherein the particles have a minimum size of at least 0.05 μm and a maximum size not exceeding 30 μm in the area subjected to the effects of fatigue-fretting. The mass proportion of the ceramic particles in the part is preferably of 5 to 40%.

This invention pertains to the field of assemblies of mechanical parts with high-level fatigue stress.

More particularly, the invention relates to a mechanical assembly of parts that are subjected to fatigue-friction constraints due to micro-movements or “fatigue-fretting.”

In the field of mechanical assemblies, it is common, in particular for the assemblies produced by mechanical connection elements, for example bolts or rivets, and subjected to high-level alternating stress, either by the very fact of stress applied to the assembly or because of intense vibratory levels, that the contact surfaces of two parts that are assembled so as to be immobilized relative to one another are, however, subjected to wear and tear because of micro-movements of the contact surfaces.

These micro-movements, often referred to as “fretting” according to English terminology, are the well-known source of deteriorations of the surfaces in question.

In particular, they are at the origin of the degradation of the surface state of parts and incipient cracking that propagates via the fatigue phenomenon and that in the highly stressed parts, as is in general the case in the parts of motors or transmission of mechanical power, can lead to irreversible damage of certain parts and in extreme cases to ruptures of parts.

In the mechanical units, the wear-and-tear phenomenon is often noted in the contact zones of bolted connections and at the bearing ring/shaft or bearing ring/bore interfaces.

The phenomenon in question will be referred to here by the expression “fatigue-fretting.”

Thus, machine designers should take into account this phenomenon to make allowance for reduced operational service lives of the parts that may be subjected to fatigue-fretting.

Various known methods also make it possible to delay the appearance of wear and tear from fretting or to better control the consequences thereof.

One method consists in designing an assembly for limiting the micro-movements, for example by using more rigid materials.

This method that delays the appearance of the fretting wear and tear requires using generally dense materials that are not suited to all of the applications, in particular to the applications of the aeronautical field.

Another method consists in limiting the friction forces by using coatings with low friction coefficients on the contact surfaces.

However, these coatings with low friction coefficients are not always hardy enough relative to the number of cycles and forces applied to the assembly.

Another method consists in applying hard deposits on the surfaces of parts that are subjected to fretting or else in performing surface treatments resulting in residual compression constraints for preventing or delaying the propagation of microcracks originating during the wear and tear of fretting.

Such surface treatments, however, prove complex in a general manner and expensive to produce.

To enhance the behavior in response to fatigue-fretting phenomena of a mechanical assembly that comprises at least two parts that are attached to one another in such a way as to keep said at least two parts locked with one another, the proposed assembly comprises at least one part from among the at least two parts produced in a material that comprises a titanium matrix or a titanium-alloy matrix and that comprises ceramic particles of titanium carbide and/or titanium boride that are dispersed in an essentially homogeneous manner within the matrix, at least in the zone that is subjected to fatigue-fretting effects because of a contact surface with the other part, the ceramic particles of titanium carbide and/or titanium boride having at least 0.05 μm in their smallest dimensions and at most 30 μm in their largest dimensions. The ceramic particles that are hard and strongly adherent to the matrix delay the formation of microcracks and limit the propagation thereof due to the effect of forces induced by the inevitable micro-movements because of the mechanical stress to which the assembly is subjected and that causes relative micro-movements between the parts that are kept locked with one another, for example by bolts, rivets, or other locking devices.

In one embodiment, at least one of the parts is integrally produced in a material that comprises a titanium matrix or a titanium-alloy matrix and that comprises ceramic particles of titanium carbide and/or titanium boride. A part that has the benefit of a slow propagation of microcracks throughout the part is thus obtained.

In one embodiment, the ceramic particles of titanium carbide and/or titanium boride have overall spherical or slightly stretched shapes whose dimensions are between 0.1 μm and 10 μm of mean diameter, preferably between 0.1 μm and 4 μm of mean diameter.

In another embodiment, which can be combined with the preceding embodiment, the ceramic particles of titanium carbide and/or titanium boride have overall elongated shapes, for example, needle shapes, whose mean dimensions are between 1 μm and 20 μm according to their largest dimensions.

Elongated shapes can also result from an alignment of essentially spherical particles.

Because of strong interactions between the matrix and the ceramic particles, in particular in terms of shearing, internal loads in the material are transferred to the ceramic particles that locally remove the load from the matrix that is more sensitive to microcracking.

In one embodiment, the mean concentration by mass of ceramic particles of titanium carbide and/or titanium boride is between 5% and 40%, more particularly between 5% and 20%, of the mass of the part that comprises the ceramic particles that are dispersed in the titanium matrix or in a titanium-alloy matrix, at least in the zone of the part that is subjected to the fatigue-fretting effects. Properties of elongation with the titanium matrix are thus preserved while providing to the part the enhancements that are expected with respect to the fatigue-fretting behavior.

The mechanical assembly that is obtained proves particularly well-suited to the assemblies in which the parts, stressed by alternating constraints or by vibrations, are attached by bolting and/or riveting and/or are coupled by a fitting that comprises, for example, grooves.

The mechanical assembly that is obtained also proves particularly well-suited to assemblies formed by a bearing ring attached to a rotary shaft or formed by a bearing ring attached in a bearing housing. In these two situations, the bearing rings are subjected to significant vibratory forces that cause micro-movements of rings relative to the associated shaft or housing and bring about the appearance of fatigue-fretting.

A particular case of mechanical assembly that is subjected to significant forces with a high-level vibratory environment corresponds to a helicopter rotor hub.

In one embodiment of the mechanical assembly, at least one part of the assembly is produced in a material that comprises a titanium matrix or a titanium-alloy matrix and that comprises ceramic particles of titanium carbide and/or titanium boride that is obtained according to a powder-metallurgy method in which precursors of the ceramic particles have been mixed with titanium powders or titanium-alloy powders, in the form of elementary powders and/or prealloyed powders, and then subjected to a consolidation. Thus, there is obtained, on the one hand, an essentially homogeneous distribution of the ceramic particles within the matrix, at least in the zone that is subjected to the effects of fatigue-fretting, thanks to the method of mixing powders, and, on the other hand, a controlling of the shape and dimensions of the ceramic particles by the shapes and dimensions of the particles of the powder of the precursors and by the monitoring of the conditions of thermomechanical treatment, in particular during the consolidation phase, which act on the growth of the ceramic particles.

The zone that is subjected to the effects of fatigue-fretting corresponds in practice to a zone in which the surfaces of the parts in contact are subjected to micro-movements at the origin of the phenomenon and that extends into the part over a thickness in which microcracks propagate under the effect of the fatigue induced by friction. In the case of highly-stressed mechanical parts, such a thickness is most often on the order of 10 mm, and even more.

By limiting the use of the material, comprising a titanium matrix or a titanium-alloy matrix, and ceramic particles of titanium carbide and/or titanium boride, to the zone that is subjected to the effects of fatigue-fretting, it is possible to produce other pieces of the part from a non-reinforced titanium alloy that provides to the parts ordinary characteristics for these alloys.

The precursors are advantageously compounds based on titanium, carbon and boron, such as TiB₂ and/or TiC, and/or B₄C, and/or boron, and/or carbon that ensure a perfect physicochemical compatibility of the ceramics that are obtained with the titanium matrix.

For example, a mixture of 98% titanium and 2% B₄C by mass provides, after reaction of the precursor with the matrix, a material that comprises 8.5% TiB and 3.9% TiC_{0.5} by mass.

In a particularly advantageous application because of, in particular, a high vibratory level, the mechanical assembly is, for example, a helicopter rotor or a helicopter rotor hub.

A mechanical assembly according to the invention comprises at least two assembled parts.

The two assembled parts are considered in the assembly to be immobilized with respect to one another, but, because of the stress to which said assembly will be subjected, the two parts will be subjected to relative micro-movements during which micro-movements the surface of each of the parts in contact with the other part will be subjected to friction because of a locking between the parts.

The two parts are, for example, two parts that are bolted to one another or an inner bearing ring attached to a shaft, or else an outer bearing ring attached in a cage.

Although kept in contact, the two parts, regardless of the forces applied to hold them, are susceptible to small relative movements that accompany friction between the surfaces of the two parts in their contact zones.

In the assembly, at least one of the two parts consists primarily of a material that is formed by a titanium matrix or a titanium alloy, reinforced by ceramic particles of titanium carbide and/or titanium boride.

The ceramic particles are distributed in the matrix in such a way as to show an essentially homogenous mean density of between 5% and 40% by mass.

The ceramic particles preferably have dimensions of between 0.1 μm and 10 μm in diameter when said particles have overall spherical or slightly stretched shapes.

The ceramic particles preferably have dimensions of between 1 μm and 20 μm, able to reach 30 μm, according to their largest dimension when said particles have overall elongated shapes, for example which are present in the shape of needles.

In this case, the transverse dimensions of the elongated particles can be as small as 0.05 μm.

It should be understood here that the recommended values of preferred dimensions of the ceramic particles are mean values and that because of the methods for formation of the ceramic particles within the matrix, the dimensions have dispersions that can lead certain ceramic particles to have dimensions beyond preferred values. Provided that the number of such particles remains proportionally low, less than several percent, their effects will be negligible.

The compatibility of titanium carbides and titanium borides with the titanium matrix provides to the material of the part a physicochemical stability that is essential to the production of parts intended for the mechanical assembly.

In the part of the assembly that is thus obtained, performance levels of lightness and temperature behavior of the titanium matrix are preserved, and the presence of ceramic particles dispersed in the matrix produces an enhancement of the elasticity module without the performance levels of elongation of the material being affected in an excessive manner owing to the limited concentration of ceramic particles whose elongation characteristics are slight compared to titanium.

The behavior of the part that is obtained with respect to the wear and tear by micro-movements and with respect to fatigue phenomena is thus enhanced because of:
The enhancement of the elasticity module of the part that consequently reduces the amplitude of the relative micro-movements between the parts of the assembly;
Blocking of microcracks by the ceramic particles at one stage where these microcracks have a length on the order of about 10 micrometers or less, and/or the deviation of the microcracks by the ceramic particles, blocking and deviation that consequently slow the propagation of cracks starting from the surface that is subjected to wear and tear by micro-movements.

Such a result is obtained by the selection of materials of the matrix and ceramic particles that are used and the development method that leads to strong interfaces, in particular in terms of shearing, between the matrix and the ceramic particles, an interface that ensures an effective transfer of loads between said matrix and said ceramic particles.

To obtain a homogeneous distribution and desired dimensions and shapes of the ceramic particles of titanium carbide and/or titanium boride in the titanium matrix, the part of the assembly is produced in a material that is obtained by a powder-metallurgy method.

In such a powder-metallurgy method, whose principles are known to one skilled in the art, the powder is an elementary powder of the matrix or a prealloyed powder of the components of the alloy, and contains precursor elements of the ceramic.

These precursor elements, for example dispersed in the form of a powder mixed with the powder of the matrix, making it possible to generate in the titanium matrix the ceramic particles of titanium carbide TiC and/or titanium boride TiB, are compounds that comprise titanium, carbon and boron, in particular TiB₂, TiC, B₄C, boron, carbon.

The ceramic particles are formed by reaction during consolidation and/or other thermomechanical treatments of the material developed from powders under pressure and temperature by known techniques, for example free fritting, fritting under load, additive production, SPS (Spark Plasma Sintering), hot isostatic compaction, extrusion, forging . . .

Controlling the mixing of the powders makes it possible to obtain variable ceramic particle densities based on the location in the part produced. For example, the presence of ceramic particles in the matrix can be limited to certain zones of the part, a priori the zones that are subjected to fatigue-fretting effects because of a contact surface with the other part. It is also possible to produce gradients in the density of the ceramic particles from zones with relatively high density of ceramic particles, the zones that are subjected to the effects of fatigue-fretting, and zones without particles, or with reduced density, based on the thickness in the part, for example because of stress of the part and risks of propagation of cracks.

By thus limiting the use of the material, comprising a titanium matrix or a titanium-alloy matrix, and ceramic particles of titanium carbide and/or titanium boride, in the zone of the part that is subjected to the effects of fatigue-fretting, it is possible to produce other pieces of the part from a conventional titanium alloy that provides to the parts specific mechanical characteristics of resistance and rigidity.

The production of a gradient in the density of the ceramic particles makes it possible to avoid overly abrupt transitions of the characteristics, in particular rigidity, in the volume of the part.

An assembly is thus obtained in which the parts have an enhanced behavior with respect to the wear and tear by micro-movements and with respect to constraints of fatigue, i.e., a reduced sensitivity to fatigue-fretting and a service life increased relative to conventional titanium alloys, with or without surface treatments, with benefits that are equivalent to the static resistance and the mass of the parts.

Such an assembly is, for example, a mechanical unit for transmission of force that is subjected to a severe vibratory environment such as a helicopter rotor or a helicopter rotor hub.

1. Mechanical assembly with enhanced behavior with respect to fatigue-fretting, resulting from fatigue combined with wear and tear by micro-movements, comprising at least two parts that are attached to one another in such a way as to keep locked with one another said at least two parts, in which assembly at least one part among the at least two parts is produced, at least in a zone of said at least one part that is subjected to effects of fatigue-fretting because of a contact surface with the other part, in a material that comprises a titanium matrix or a titanium-alloy matrix and that comprises ceramic particles of titanium carbide and/or titanium boride that are dispersed in an essentially homogeneous manner within the matrix, with said particles having at least 0.05 μm in their smallest dimensions and at most 30 μm in their largest dimensions.

2. Mechanical assembly according to claim 1, in which at least one part among the at least two parts is produced entirely in a material that comprises a titanium matrix or a titanium-alloy matrix and that comprises ceramic particles of titanium carbide and/or titanium boride.

3. Mechanical assembly according to claim 1, in which all or part of the ceramic particles of titanium carbide and/or titanium boride have overall spherical or slightly stretched shapes whose dimensions are between 0.1 μm and 10 μm, more particularly between 0.1 μm and 4 μm, of mean diameter.

4. Mechanical assembly according to claim 1, in which all or part of the ceramic particles of titanium carbide and/or titanium boride have overall elongated shapes, for example needle shapes, whose dimensions are between 1 μm and 20 μm according to their largest mean dimensions.

5. Mechanical assembly according to claim 1, in which the mean concentration by mass of ceramic particles of titanium carbide and/or titanium boride, at least in a zone that is subjected to fatigue-fretting effects, is between 5% and 40%, more particularly between 5% and 20%, of the mass of the part that comprises said ceramic particles distributed in the titanium matrix or titanium-alloy matrix.

6. Mechanical assembly according to claim 1, in which the at least two parts are attached by a bolting, by a riveting, or by a fitting, for example a fitting that comprises grooves.

7. Mechanical assembly according to claim 1, in which one of the at least two parts of the assembly is a bearing ring and the other of the at least two parts is a shaft on which said ring is attached or is a housing in which said ring is attached.

8. Mechanical assembly according to claim 1, in which the at least one part that is produced in a material that comprises a titanium matrix or a titanium-alloy matrix and that comprises ceramic particles of titanium carbide and/or titanium boride is produced according to a powder-metallurgy method in which precursors of the ceramic particles have been mixed with titanium powders or titanium-alloy powders, in the form of elementary powders and/or prealloyed powders, and then subjected to a consolidation.

9. Assembly according to claim 8, in which the precursors are compounds based on titanium, carbon, and boron, such as TiB₂, and/or TiC, and/or B₄C, and/or boron, and/or carbon.

10. Helicopter rotor that comprises at least one mechanical assembly in accordance with claim 1.

11. Helicopter rotor hub that comprises at least one mechanical assembly in accordance with claim 1.
